(19) United States
(12) Patent Application Publication
(10) Pub. No.: US 2026/0254038 A1
(43) Pub. Date: Aug. 27, 2026

(54) SECONDARY ENERGY STORAGE DEVICE AND METHOD OF FORMING SAME

(71) Applicant: GM Global Technology Operations LLC, Detroit, MI (US)

(72) Inventors: Seung-Woo Chu, Sterling Heights, MI (US); Wei Zeng, Oakland Township, MI (US); Ryan P. Hickey, New York, NY (US); David R. Clark, Grosse Pointe Woods, MI (US)

(73) Assignee: GM GLOBAL TECHNOLOGY OPERATIONS LLC, Detroit, MI (US)

(21) Appl. No.: 19/063,653

(22) Filed: Feb. 26, 2025

(51) Int. Cl. H01M 50/325; H01M 10/0525; H01M 10/058; H01M 50/103; H01M 50/124; H01M 50/15

(52) U.S. Cl. CPC H01M 50/325; H01M 10/0525; H01M 10/058; H01M 50/103; H01M 50/1245; H01M 50/15; H01M 2220/20

(57) ABSTRACT

A secondary energy storage device includes a rigid enclosure having a rectangular prism shape and defining a cavity therein. The rigid enclosure includes a surface having a feature that is protectable from contact with at least one of a gas and a particle present in an environment ambient to the surface and having a temperature that is higher than a melting point temperature of the feature. The secondary energy storage device also includes a polymeric film covering the feature and a cured film formed from a curable ceramic coating. The cured film is disposed on and covers the polymeric film and is configured to reinforce and protect the feature from contact with the at least one of the gas and the particle. A method of forming the secondary energy storage device is described.

### INTRODUCTION

The disclosure relates to a secondary energy storage device and a method of forming the secondary energy storage device.

Energy storage devices, such as batteries, are useful for converting chemical energy into electrical energy, and may be described as primary or secondary. Primary energy storage devices are generally non-rechargeable, whereas secondary energy storage devices are readily rechargeable and may be restored to a full charge after use. As such, secondary energy storage devices may be useful for applications such as powering electronic devices, tools, machinery, and vehicles. For example, secondary energy storage devices for vehicle applications may be recharged external to the vehicle via a plug-in electrical outlet, or onboard the vehicle via a regenerative event.

One type of secondary energy storage device, a lithium ion secondary battery, may include a negative electrode or anode, a positive electrode or cathode, and an electrolyte disposed between the positive and negative electrodes. The negative electrode may be formed from a material that is capable of incorporating and releasing lithium ions during charging and discharging of the lithium ion secondary battery. More specifically, during charging of the lithium ion secondary battery, lithium ions may move from the positive electrode to the negative electrode and embed in the material. Conversely, during battery discharge, lithium ions may be released from the material and move from the negative electrode to the positive electrode. Under certain operating conditions, such secondary energy storage devices may experience changes in ambient environment and mechanical properties.

### SUMMARY

A secondary energy storage device includes a rigid enclosure having a rectangular prism shape and defining a cavity therein. The rigid enclosure includes a surface having a feature that is protectable from contact with at least one of a gas and a particle present in an environment ambient to the surface and having a temperature that is higher than a melting point temperature of the feature. The secondary energy storage device also includes a polymeric film covering the feature and a cured film formed from a curable ceramic coating. The cured film is disposed on and covers the polymeric film and is configured to reinforce and protect the feature from contact with the at least one of the gas and the particle.

In one aspect, the rigid enclosure may have a front face extending along a central longitudinal axis. The surface may be a cap plate that contacts and is disposed perpendicular to the front face and extends along an axis that is parallel to the central longitudinal axis. The feature may be a vent defined by the cap plate and configured for alternatingly fluidly communicating with and sealing off the cavity from the environment ambient to the surface.

In an additional aspect, the cap plate may define a vent channel therethrough that is disposed in fluid communication with the cavity and has an inner face extending from the surface. The cap plate may include a sheet disposed within the vent channel against the inner face that is configured to seal the cavity from the environment ambient to the surface during a first condition and vent the cavity to the environment ambient to the surface during a second condition.

In another aspect, the sheet may define a plurality of notches therein configured to weaken the sheet such that the sheet is severable during the second condition.

In a further aspect, the polymeric film may adhere to the surface and cover the vent channel.

In one aspect, the cap plate may further include a protrusion extending from the surface at the vent and disposed adjacent the inner face.

In an additional aspect, the polymeric film may be disposed on the protrusion and covers the vent channel.

In another aspect, the protrusion may have a first outer dimension along the axis and the polymeric film may have a second outer dimension along the axis that is larger than the first outer dimension.

In a further aspect, the protrusion may include an outer face spaced opposite the inner face and the cured film may be disposed on the surface adjacent to and in contact with the outer face.

In one aspect, the cured film may have a thickness of from 10 microns to 400 microns.

In an additional aspect, the feature may be a cell terminal.

In another aspect, the feature may be an entirety of the surface.

In a further aspect, a vehicle may include the secondary energy storage device.

A secondary energy storage device includes a rigid enclosure having a rectangular prism shape and defining a cavity therein. The rigid enclosure includes a surface having a feature that is protectable from contact with at least one of a gas and a particle present in an environment ambient to the surface and having a temperature that is higher than a melting point temperature of the feature. The secondary energy storage device also includes a ceramic coating disposed on and covering the feature and configured to reinforce and protect the feature from contact with the at least one of the gas and the particle.

In one aspect, the ceramic coating may be a ceramic yarn tape that includes an adhesive disposed in contact with the surface.

A method of forming a secondary energy storage device includes placing a polymeric film on a feature of a surface of a rigid enclosure. The rigid enclosure has a rectangular prism shape and defines a cavity therein. The feature is protectable from contact with at least one of a gas and a particle present in an environment ambient to the surface and having a temperature that is higher than a melting point temperature of the feature. The method also includes disposing a curable ceramic coating on the polymeric film to thereby cover the polymeric film. The method further includes curing the curable ceramic coating to form a cured film disposed on and covering the polymeric film. The cured film is configured to reinforce and protect the feature from contact with the at least one of the gas and the particle. The method also includes, after curing, assembling the rigid enclosure to thereby seal the cavity from the environment ambient to the surface and form the secondary energy storage device.

In one aspect, disposing may include spraying the curable ceramic coating in slurry form onto the polymeric film, and curing may include fully hardening the curable ceramic coating before assembling the rigid enclosure.

In an additional aspect, the rigid enclosure may include a front face extending along a central longitudinal axis and the surface may be a cap plate that is disposed perpendicular to the front face and extends along an axis that is parallel to the central longitudinal axis. The method may further include, after curing, attaching the cap plate to the front face.

In another aspect, disposing the curable ceramic coating on the polymeric film may include coating a first portion of the surface that is less than an entirety of the surface to thereby form a second portion of the surface that is free from the curable ceramic coating. Attaching may include welding the cap plate to the front face at the second portion.

In a further aspect, coating the first portion may include applying a mask to the surface at the second portion.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a side view of a secondary energy storage device;

FIG. 2 is a schematic illustration of an exploded, perspective view of a vehicle including a plurality of secondary energy storage devices of FIG. 1 that are arranged into a plurality of secondary energy storage packs arranged into a secondary energy storage module.

FIG. 3 is a schematic illustration of a top view of a cap plate of the secondary energy storage device of FIG. 1.

FIG. 4 is a schematic illustration of a cross-sectional view of one embodiment of the cap plate of FIG. 3.

FIG. 5 is a schematic illustration of a cross-sectional view of another embodiment of the cap plate of FIG. 3.

FIG. 6 is a schematic illustration of a cross-sectional view of a further embodiment of the cap plate of FIG. 3.

FIG. 7 is a schematic illustration of a cross-sectional view of yet another embodiment of the cap plate of FIG. 3.

FIG. 8 is a schematic illustration of a cross-sectional view of an additional embodiment of the secondary energy storage device of FIG. 1.

FIG. 9 is a schematic flow diagram of a method of forming the secondary energy storage device of FIG. 1.

### DETAILED DESCRIPTION

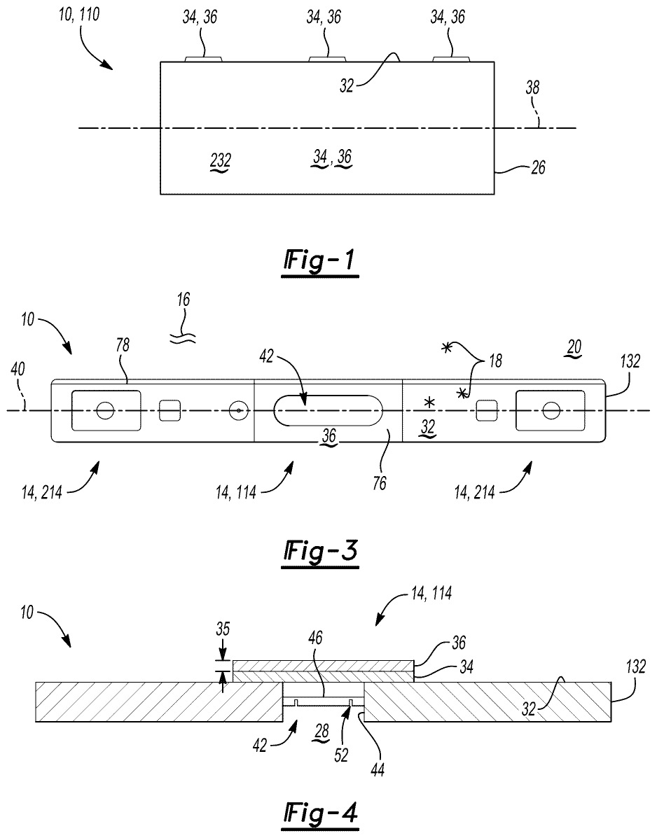

Referring to the Figures, wherein like reference numerals refer to like elements, a secondary energy storage device 10 (FIG. 1) and a method 12 (FIG. 9) of forming the secondary energy storage device 10 are shown generally. The secondary energy storage device 10 may be useful for applications requiring robust mechanical integrity during operation under various conditions. In particular, the secondary energy storage device 10 and method 12 may be useful for applications requiring protection of various features 14 (FIG. 3) of the secondary energy storage device 10 from contact with gas 16 (FIG. 3) and/or particles 18 (FIG. 3) in an environment 20 (FIG. 3) ambient to the secondary energy storage device 10, wherein the gas 16 and/or particles 18 have a temperature that is higher than a melting point temperature of the feature 14. For example, the secondary energy storage device 10 may be useful for applications in which neighboring or adjacent components may experience a change in operating conditions that may increase a temperature of the environment 20 surrounding the secondary energy storage device 10 and/or may increase a likelihood of the secondary energy storage device 10 coming into contact with heated gas 16 and/or heated particles 18. As such, the secondary energy storage device 10 may be suitable for applications requiring operation of the secondary energy storage device 10 in harsh or unexpected conditions, and the method 12 may be suitable for high-volume manufacturing requiring handling and welding processes.

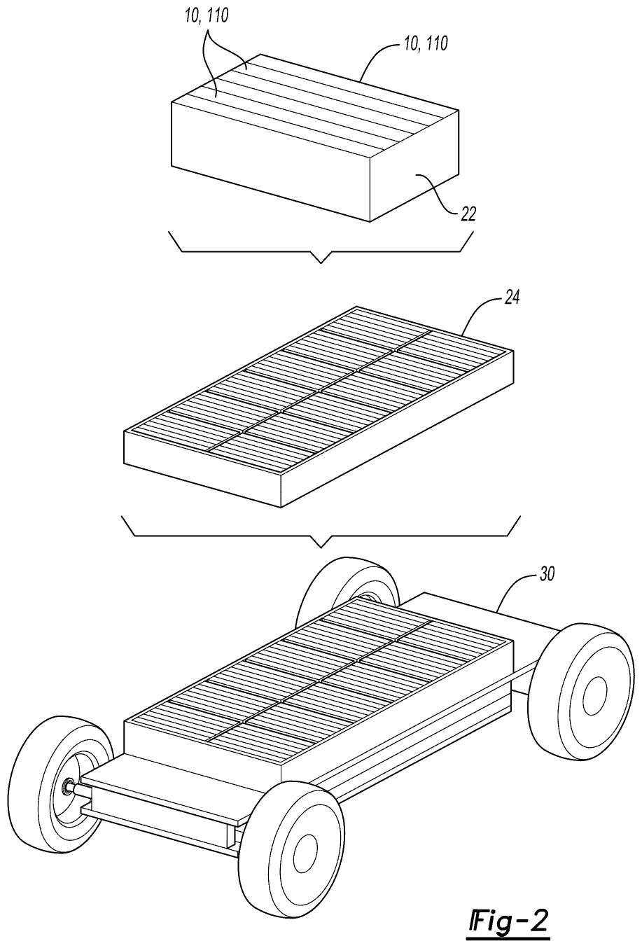

In one non-limiting example, the secondary energy storage device 10 may be a lithium ion secondary battery as shown in FIG. 1. That is, the secondary energy storage device 10 may be useful for applications requiring lithium ion secondary batteries having excellent electrical conductivity, mechanical integrity, specific energy capacity, performance, manufacturing cost, and operating life. Therefore, the secondary energy storage device 10 may be useful for a variety of applications requiring lithium ion secondary batteries, such as, but not limited to, electronic devices, tools, machinery, and vehicles 30 (FIG. 2). For example, the secondary energy storage device 10 may be useful for lithium ion secondary batteries for electric and hybrid electric vehicles 30. However, it is to be appreciated that the secondary energy storage device 10 may also be useful for non-automotive applications, such as, but not limited to, household and industrial power tools and electronic devices.

Referring now to FIG. 2 and for purposes of general explanation pertaining to automotive applications, a plurality of secondary energy storage devices 10 may be combined to form a secondary energy storage module 22, e.g., a lithium ion secondary battery module. The secondary energy storage module 22 may be useful for automotive applications such as a hybrid electric vehicle (HEV), an electric vehicle (EV), a plug-in hybrid electric vehicle (PHEV), and the like. Further, a plurality of secondary energy storage modules 22 may be combined to form a secondary energy storage pack 24, e.g., a lithium ion secondary battery pack, as also shown in FIG. 2. By way of example, the secondary energy storage pack 24 may be sufficiently sized to provide a voltage for powering an HEV, an EV, a PHEV, and the like, e.g., approximately 300 to 400 volts or more, depending on the required application.

Referring again to FIG. 2, the secondary energy storage module 22 may include a plurality of secondary energy storage devices 10 positioned adjacent to and spaced from one another. That is, the secondary energy storage device 10 may be suitable for stacking. More specifically and as best shown in FIG. 1, the secondary energy storage device 10 includes a rigid enclosure 26 having a rectangular prism shape or cuboid shape and may be characterized as a prismatic secondary energy storage device 10. The rigid enclosure 26 may be formed from a metal, such as aluminum or steel, and defines a cavity 28 (FIGS. 4-8) that may be sealed to enclose at least a portion of a cathode, an anode, a separator, and an electrolyte.

Therefore, the plurality of secondary energy storage devices 10 may be stacked or otherwise placed adjacent to each other to form a cell stack, i.e., the secondary energy storage module 22. Further, although not shown, additional layers, such as, but not limited to, frames and/or cooling layers may also be positioned in the space between individual secondary energy storage devices 10. The actual number of secondary energy storage devices 10 may be expected to vary with the required voltage output of each secondary energy storage module 22. Likewise, the number of interconnected secondary energy storage modules 22 may vary to produce the total output voltage for a specific application.

In general, during operation of the secondary energy storage device 10, a chemical redox reaction may transfer electrons between a region of relatively negative potential to a region of relatively positive potential to thereby cycle, i.e., charge and discharge, the secondary energy storage device 10 and the secondary energy storage pack 24 to provide voltage to power applications. In particular, a plurality of lithium ions (not shown) may transfer between a positive electrode (not shown) and a negative electrode (not shown) during charging and discharging of the secondary energy storage device 10.

Therefore, the secondary energy storage device 10 and method 12 may be useful for automotive applications such as, but not limited to, vehicles 30 (FIG. 2) including internal combustion engine vehicles, electric vehicles, hybrid vehicles, and the like. For example, the vehicle 30 may be a motor vehicle powered by a motive power source including at least one of an internal combustion engine, an electric motor, and an energy storage device, and the vehicle 30 may include the secondary energy storage device 10.

Further, the vehicle 30 may be configured for autonomous or automated driving in which the vehicle 30 may be controlled or driven by technology including hardware and software, whether remote to the vehicle 30 or onboard the vehicle 30, that is capable of driving the vehicle 30 without active physical control by a human operator. For example, autonomous or automated driving tasks may include, but are not limited to, object and event detection, recognition, and classification; object and event response; maneuver planning; steering, turning, lane-keeping, signaling, and lane changing; and acceleration and deceleration.

Alternatively, the secondary energy storage device 10 and method 12 may be useful for non-automotive applications such as, but not limited to, aerospace, aviation, marine, mass transportation, agricultural, industrial, and rail applications. For example, the vehicle 30 may be, but is not limited to, a commercial vehicle, industrial vehicle, passenger vehicle, automated guided vehicle (AGV), aircraft, watercraft, train, trolley, bus, or the like. It is also contemplated that the vehicle 30 may be a mobile platform, such as an airplane, all-terrain vehicle (ATV), boat, personal movement apparatus, robot, and the like to accomplish the purposes of this disclosure.

### Secondary Energy Storage Device

Referring now to FIG. 1, the rigid enclosure 26 of the secondary energy storage device 10 includes a surface 32 having the feature 14 (FIG. 3) that is protectable from contact with at least one of the gas 16 (FIG. 3) and the particle 18 (FIG. 3) present in an environment 20 (FIG. 3) ambient to the surface 32 and having a temperature that is higher than a melting point temperature of the feature 14. For example, as best shown in FIG. 3, the surface 32 may be a cap plate 132 that extends along a top of the secondary energy storage device 10. Alternatively, as best shown in FIG. 1, the surface 32 may be a front face 232 of the secondary energy storage device 10. Although not shown, the surface 32 may alternatively be a bottom face of the secondary energy storage device 10 that is spaced apart from the cap plate 132.

With continued reference to FIGS. 1 and 3, the feature 14 may be a sensitive or protectable area of the surface 32. In one non-limiting example set forth in more detail below, the feature 14 may be a vent 114 (FIG. 3) defined by the cap plate 132 and configured for alternatingly fluidly communicating with and sealing off the cavity 28 from the environment 20 ambient to the surface 32. For example, the vent 114 may nominally seal off contents of the cavity 28 from the environment 20, but may, in some situations, allow fluid communication between the cavity 28 and the environment 20 to exhaust contents, e.g., gas 16 and/or particles 18, from the cavity 28 or change conditions, e.g., pressure or temperature, within the cavity 28.

In another non-limiting example, the feature 14 may be a cell terminal 214 (FIG. 3). In yet another nonlimiting example, the feature 14 may be an entirety of the surface 32. Additionally or alternatively, a plurality of surfaces 32 may include one or more protectable features 14. For example, the cap plate 132 may include one or more cell terminals 214 and another surface 32 such as the bottom face spaced apart from the cell terminals 214 may define the vent 114.

Such features 14 may be particularly susceptible to changes in structure or function during manufacturing or operating conditions that include, for example, abrasion, temperature excursions, exposure to contaminants, and the like. For example, during assembly of the rigid enclosure 26 and secondary energy storage device 10, the entirety of one or more surfaces 32 may require protection from abrasion during handling and transfer operations. Similarly, during operation of the secondary energy storage device 10, the vent 114 and cell terminals 214 may require protection from heated gas 16 and/or particles 18, e.g., vaporized organic solvent, particulates from coated substrates, and the like, that may be expelled by an adjacent component or present in the environment 20 (FIG. 1) ambient to the secondary energy storage device 10.

Referring now to FIG. 4, and as set forth in more detail below, the secondary energy storage device 10 also includes a polymeric film 34 covering the feature 14. The polymeric film 34 may be formed from a polymer, such as, but not limited to, polyethylene terephthalate. The polymeric film 34 may provide a first layer of protection for the feature 14.

Further, the secondary energy storage device 10 also includes a cured film 36 formed from a curable ceramic coating, disposed on and covering the polymeric film 34, and configured to reinforce and protect the feature 14 from contact with the at least one of the gas 16 and the particle 18. That is, the cured film 36 may provide a second layer of protection for the feature 14.

The curable ceramic coating may be characterized as a high solids ceramic coating. More specifically, the curable ceramic coating may be a slurry formed from components such as, but not limited to, alumina, aluminum tri-hydroxide, filler, a two-part silicon resin, and a two-part epoxy polymeric binder. For example, the curable ceramic coating may include alumina and a two-part silicone resin, such as SILIKOPHEN® AC 900 methyl phenyl silicone resin and SILIKOPHEN® AC 1000 methyl silicone resin, each commercially available from Evonik of Sand Creek, Michigan. Alternatively, the curable coating may include aluminum tri-hydroxide and a two-part epoxy polymeric binder that may be cured in an oven and may allow for a comparatively thinner coating thickness due to energy absorption properties when directly contacted with at least one of the heated gas 16 and particle 18.

Further, the curable ceramic coating may be at least one of thermally curable, curable upon contact with moisture, such as via room temperature vulcanization, and curable upon exposure to ultraviolet radiation. For example, the terminology thermally curable refers to a material that hardens or cures through the application of heat, where a chemical reaction occurs within the material when exposed to elevated temperatures, causing the material to solidify and reach its desired properties. Therefore, as used herein, thermally curable may also refer to materials that may cure at room temperature when room temperature is an elevated temperature as compared to an application temperature of the material. The ceramic coating may also be curable by exposing the ceramic coating to moisture, for example, moisture in the ambient air. That is, the curable ceramic coating may be a room temperature vulcanizing ceramic coating that reacts with moisture to harden and cure. Further, the ceramic coating may be a ultraviolet curable ceramic coating that hardens via a photochemical process upon exposure to light or radiation having a wavelength within the ultraviolet spectrum. That is, upon exposure to ultraviolet light, the ceramic coating may polymerize and solidify to form the cured film 36.

When cured, the cured film 36 may have a melting point temperature of from 400° C. to 1,500° C. That is, the cured film 36 may provide the feature 14 with protection from contact with or melting caused by gas 16 and/or particles 18 having a temperature of less than or equal to 1,500° C.

Further, the cured film 36 may have a thickness 35 (FIG. 4) of from 10 microns to 400 microns, e.g., from 30 microns to 380 microns, or from 50 microns to 350 microns, or from 100 microns to 300 microns, or from 150 microns to 250 microns, wherein 1 micron is equal to 1×10⁻⁶ meters. That is, the cured film 36 may be comparatively thin and yet protect and reinforce the feature 14. At thicknesses 35 of less than 10 microns, the cured film 36 may not provide sufficient protection and reinforcement to the polymeric film 34 and feature 14. At thicknesses 35 of greater than 400 microns, the cured film 36 may add undesirable weight to the secondary energy storage device 10 and/or may interfere with stackability and electrical connectivity of adjacent secondary energy storage devices 10.

As such, the combination of the polymeric film 34 and the cured film 36 disposed on and covering the polymeric film 34 may cover and protect the sensitive feature 14 of the secondary energy storage device 10 from contact with the heated gas 16 and/or particle 18 that may otherwise change the structure and/or function of the feature 14. Stated differently, the polymeric film 34 and the cured film 36 formed from the curable ceramic coating protect the feature 14 from melting upon exposure to harsh operating or manufacturing conditions. For example, the combination of the polymeric film 34 and cured film 36 may prevent heated gas 16 and/or particles 18 from accumulating or settling within the vent 114, which could otherwise change operation of the vent 114. Likewise, the polymeric film 34 and cured film 36 may prevent heated gas 16 and/or particles 18 from accumulating or settling on the cell terminals 214, which could otherwise cause electrical shorting and change operation of the cell terminals 214.

Therefore, the polymeric film 34 and cured film 36 may ensure that the sensitive feature 14 maintains a nominal structure and a nominal function, even when components adjacent to or nearby the secondary energy storage device 10 may expel gas 16 and/or particles 18 having elevated temperatures. The combination of the films 34, 36 may consequently interrupt or decrease occurrence of a chain reaction that may otherwise cause an increase in temperature and/or pressure in the secondary energy storage device 10. In addition, the combination of the polymeric film 34 and cured film 36 may eliminate a need for a perforated mica sheet and associated framing to be placed over the secondary energy storage device 10 for protection.

### Example Configurations

In one example, the rigid enclosure 26 may have a front face 232 (FIG. 1) extending along a central longitudinal axis 38. That is, the front face 232 may have a generally rectangular shape, may be formed from metal, and may have a longest dimension extending along the central longitudinal axis 38. As best shown in FIG. 3, the surface 32 may be the cap plate 132 that contacts and is disposed perpendicular to the front face 232 and extends along an axis 40 that is parallel to the central longitudinal axis 38. For this example, the feature 14 may be the vent 114 defined by the cap plate 132 and configured for alternatingly fluidly communicating with and sealing off the cavity 28 from the environment 20 ambient to the surface 32.

Referring now to FIG. 4, more specifically, the cap plate 132 may define a vent channel 42 therethrough that is disposed in fluid communication with the cavity 28 and has an inner face 44 extending from the surface 32. The cap plate 132 may also include a sheet 46 disposed within the vent channel 42 against the inner face 44, e.g., contacting or abutting the inner face 44, that is configured to seal the cavity 28 from the environment 20 ambient to the surface 32 during a first condition, and vent the cavity 28 to the environment 20 ambient to the surface 32 during a second condition. That is, the sheet 46 may be transitionable from one position or configuration during the first condition, which may represent a nominal operating or manufacturing condition, to another position or configuration during the second condition, which may represent a temperature excursion or contact with at least one of the heated gas 16 and particle 18. Stated differently, the sheet 46 may be transitionable between a first position in which the cavity 28 is sealed and a second position in which the cavity 28 is vented.

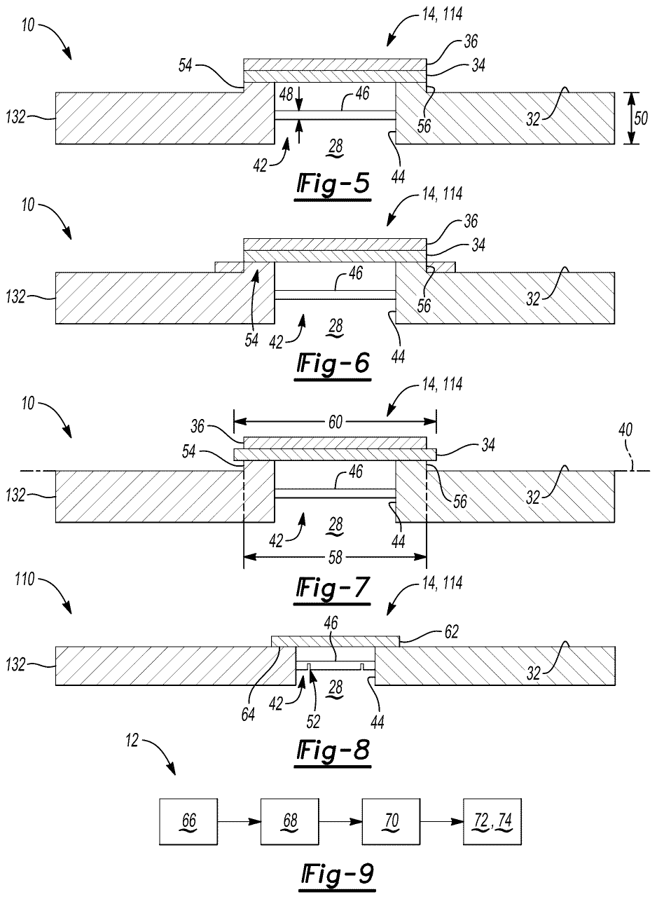

For example, as described with reference to FIG. 5, the sheet 46 may be formed from a metal, such as aluminum, but may have a first thickness 48, e.g., from 0.1 millimeters (mm) to 0.5 mm, that is smaller than a second thickness 50 of the cap plate 132, e.g., from 1 mm to 3 mm. That is, the sheet 46 may be relatively thin as compared to other portions of the cap plate 132. During the first condition, the sheet 46 may seal off the cavity 28 from the environment 20 ambient to the surface 32 and remain closed. As shown in FIG. 4, the sheet 46 may define a plurality of notches 52 therein configured to weaken the sheet 46 such that the sheet 46 is severable during the second condition. That is, during the second condition, the sheet 46 may flex and sever at the plurality of notches 52 upon, for example, an over pressurization of the cavity 28 so that the contents of the cavity 28 may fluidly communicate with the environment 20 through the vent channel 42.

In this example, as shown in FIG. 4, the polymeric film 34 may adhere to the surface 32 and cover the vent channel 42. As such, the polymeric film 34 may protect the vent channel 42 from debris, inadvertent contact with tooling, and the like and may protect the sheet 46 from damage or a change in function during manufacturing and transport of the secondary energy storage device 10. Further, the cured film 36 disposed on the polymeric film 34 may protect the sheet 46 from melting during operation under a condition that includes risk of exposure to or impingement by the heated gas 16 and/or particle 18.

Referring now to FIG. 5, in another non-limiting example, the cap plate 132 may further include a protrusion 54 or rim extending from the surface 32 at the vent 114 and disposed adjacent the inner face 44. The protrusion 54 may have a height of from 20 microns to 80 microns, e.g., 40 microns. As shown in FIG. 5, for this example, the polymeric film 34 may be disposed on the protrusion 54 and cover the vent channel 42 and the cured film 36 may be disposed on and cover the polymeric film 34.

Referring now to FIG. 6, in an additional non-limiting example, the protrusion 54 may include an outer face 56 spaced opposite the inner face 44 and the cured film 36 may be disposed on the surface 32 adjacent to and in contact with the outer face 56. Such overhang of the cured film 36 such that the cured film 36 is in contact with the outer face 56 at the surface 32 may ensure sufficient operation of the vent 114 when desired. That is, the cured film 36 may not hinder operation of the vent 114 during the second condition in which the cavity 28 fluidly communicates with the environment 20 ambient to the surface 32.

Referring now to FIG. 7, in a further non-limiting example, the protrusion 54 may have a first outer dimension 58 along the axis 40 and the polymeric film 34 may have a second outer dimension 60 along the axis 40 that is larger than the first outer dimension 58. That is, the polymeric film 34 may extend past the outer face 56 of the protrusion 54 along the axis 40 to thereby enable excellent tolerance of the cured film 36 on the polymeric film 34. Although shown with the cured film 36 having a comparatively smaller first outer dimension 58 than the second outer dimension 60 of the polymeric film 34, the cured film 36 may alternatively have a first outer dimension 58 that is greater than or equal to the second outer dimension 60. Such dimensions 58, 60 likewise may ensure sufficient operation of the vent 114 when desired. That is, the dimensions 58, 60 may not hinder operation of the vent 114 during the second condition in which the cavity 28 fluidly communicates with the environment 20 ambient to the surface 32.

Although not shown in detail, the polymeric film 34 and cured film 36 may also be disposed on the entirety of a portion of the rigid enclosure 26, such as, but not limited to, the front face 232 (FIG. 1). Such overall coating for a face of the rigid enclosure 26 may provide added protection against operating environments in which an adjacent or nearby component of a secondary energy storage module 22 (FIG. 2) or pack 24 (FIG. 2) changes structure or mechanical integrity and thereby increases a chance that the rigid enclosure 26 may contact or be impinged by heated gas 16 and/or particles 18. As such, the secondary energy storage device 10 may minimize a need for additional protective or mitigation components, such as insulation, thermal protection, framing, shielding, layering, and the like, to be adjoined to the secondary energy storage device 10.

Referring now to FIG. 8, in another embodiment, the secondary energy storage device 110 includes the rigid enclosure 26 including the surface 32 and feature 14 as set forth above, and also includes a ceramic coating 62 disposed on and covering the feature 14 and configured to reinforce and protect the feature 14 from contact with the at least one of the gas 16 and the particle 18. For this embodiment, the ceramic coating 62 may be a ceramic yarn tape that includes an adhesive 64 disposed in contact with the surface 32. Suitable ceramic yarn tapes may include, but are not limited to, ceramic fiber tapes such as 3M™ Nextel™ Ceramic Woven Tapes 312 and 440, commercially available from 3M of St. Paul, Minnesota; calcium-silicate insulation tapes such as basalt tape; and the like.

### Method of Forming the Secondary Energy Storage Device

Referring now to FIG. 9, the method 12 of forming the secondary energy storage device 10 includes placing 66 the polymeric film 34 on the feature 14 of the surface 32 of the rigid enclosure 26. For example, placing 66 may include adhering the polymeric film 34 to the surface 32 to thereby cover the feature 14 as set forth above. The polymeric film 34 may be placed on the feature 14 prior to other manufacturing or assembly operations to protect the feature 14 from abrasion, contaminants, unintended puncture, and the like.

Further, the method 12 includes disposing 68 the curable ceramic coating on the polymeric film 34 to thereby cover the polymeric film 34. For example, disposing 68 may include aligning the surface 32 in a conveyor system and spraying or otherwise applying the curable ceramic coating in slurry form to the polymeric film 34. In some examples, as best described with reference to FIG. 2, disposing 68 the curable ceramic coating on the polymeric film 34 may also include applying a mask to the surface 32 to control which portion(s) of the surface 32 are coated with the curable ceramic coating.

That is, disposing 68 may include coating a first portion 76 (FIG. 3) of the surface 32 that is less than an entirety of the surface 32 to thereby form a second portion 78 (FIG. 3) of the surface 32 that is free from the curable ceramic coating. Stated differently, coating the first portion 76 may include applying a mask to the surface 32 at the second portion 78. A size of the mask may be tailored to, for example, a size of a weld required to join a component of the rigid enclosure 26, e.g., the cap plate 132, to a remainder of the rigid enclosure 26 during welding operations.

The method 12 also includes curing 70 the curable ceramic coating to form the cured film 36 disposed on and covering the polymeric film 34. In one example, curing 70 may include baking or heating the curable ceramic coating in an oven at conditions which may include, but are not limited to, a temperature of from 80° C. to 100° C., a relative humidity of from 5% to 15%, and a bake time of from 1 hour to 5 hours. In another example, curing 70 may include room temperature vulcanizing the ceramic coating. In yet another example, curing 70 may include hardening or solidifying the ceramic coating by exposing the ceramic coating to ultraviolet light or radiation.

Advantageously, curing 70 may fully cure the curable ceramic coating to form the cured film 36 and protect the feature 14 without requiring an entirety of the rigid enclosure 26 or secondary energy storage device 10 to be baked or exposed to elevated temperatures. That is, disposing 68 may include spraying the curable ceramic coating in slurry form onto the polymeric film 34, and curing 70 may include fully hardening or fully solidifying or fully curing the curable ceramic coating before assembling 72 the rigid enclosure 26. Therefore, the feature 14 may be protected by the polymeric film 34 and cured film 36 before the secondary energy storage device 10 is fully assembled. As such, disposing 68 the curable ceramic coating and curing 70 may occur in a manufacturing location other than a final assembly location of the secondary energy storage device 10.

Therefore, the method 12 may be useful for high volume manufacturing operations. For example, since other protective coatings may require significant cure time at room temperature, and since lithium ion secondary batteries cannot be baked in an oven when fully assembled without degrading the batteries, the method 12 may solve these challenges by forming the cured film 36 disposed on the polymeric film 34 before the rigid enclosure 26 is fully sealed, i.e., before the secondary energy storage device 10 is fully assembled. In other words, the method 12 allows for individual components of the secondary energy storage device 10, e.g., the cap plate 132, front face 232, or other surfaces 32 defining the protectable feature 14, to be manufactured first prior to cell assembly of the secondary energy storage device 10. That is, the method 12 allows for the individual components having the protectable feature 14 to arrive at cell assembly operations fully cured and process compliant for high volume manufacturing of the secondary energy storage device 10.

The method 12 also includes, after curing 70, assembling 72 the rigid enclosure 26 to thereby seal the cavity 28 from the environment 20 ambient to the surface 32 and thereby form the secondary energy storage device 10. That is, prior to assembling 72, one or more portions of the rigid enclosure 26 may be brought into proximity with another portion or portions of the rigid enclosure 26. Assembling 72 may then include welding together the rigid enclosure 26 to fully seal the cavity 28. For example, the method 12 may further include, after curing 70, attaching 74 the cap plate 132 to the front face 232 by welding. Attaching 74 may include welding the cap plate 132 to the front face 232 at the second portion 78 (FIG. 3). Advantageously, disposing 68 the curable ceramic coating and curing 70 to form the cured film 36 before assembling 72 allows for excellent manufacturing cycle times and cost-efficient manufacturing operations.

Therefore, in summary, the secondary energy storage device 10 and method 12 may be useful for applications requiring protection of various features 14 of the secondary energy storage device 10 from contact with gas 16 and particles 18 in an environment 20 ambient to the secondary energy storage device 10 having a temperature that is higher than a melting point temperature of the feature 14. Further, the method 12 and secondary energy storage devices 10 may be suitable for high-volume manufacturing requiring handling and welding processes and for applications requiring operation of the secondary energy storage device 10 in harsh conditions. In particular, the secondary energy storage device 10 may be useful for applications requiring prismatic lithium ion secondary batteries having excellent electrical conductivity, mechanical integrity, specific energy capacity, performance, manufacturing cost, and operating life.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A secondary energy storage device comprising:
a rigid enclosure having a rectangular prism shape and defining a cavity therein, wherein the rigid enclosure includes a surface having a feature that is protectable from contact with at least one of a gas and a particle present in an environment ambient to the surface and having a temperature that is higher than a melting point temperature of the feature;
a polymeric film covering the feature; and
a cured film formed from a curable ceramic coating, disposed on and covering the polymeric film, and configured to reinforce and protect the feature from contact with the at least one of the gas and the particle.

2. The secondary energy storage device of claim 1, wherein the rigid enclosure has a front face extending along a central longitudinal axis;
wherein the surface is a cap plate that contacts and is disposed perpendicular to the front face and extends along an axis that is parallel to the central longitudinal axis; and
wherein the feature is a vent defined by the cap plate and configured for alternatingly fluidly communicating with and sealing off the cavity from the environment ambient to the surface.

3. The secondary energy storage device of claim 2, wherein the cap plate defines a vent channel therethrough that is disposed in fluid communication with the cavity and has an inner face extending from the surface; and
wherein the cap plate includes a sheet disposed within the vent channel against the inner face that is configured to seal the cavity from the environment ambient to the surface during a first condition and vent the cavity to the environment ambient to the surface during a second condition.

4. The secondary energy storage device of claim 3, wherein the sheet defines a plurality of notches therein configured to weaken the sheet such that the sheet is severable during the second condition.

5. The secondary energy storage device of claim 3, wherein the polymeric film adheres to the surface and covers the vent channel.

6. The secondary energy storage device of claim 3, wherein the cap plate further includes a protrusion extending from the surface at the vent and disposed adjacent the inner face.

7. The secondary energy storage device of claim 6, wherein the polymeric film is disposed on the protrusion and covers the vent channel.

8. The secondary energy storage device of claim 7, wherein the protrusion has a first outer dimension along the axis and the polymeric film has a second outer dimension along the axis that is larger than the first outer dimension.

9. The secondary energy storage device of claim 7, wherein the protrusion includes an outer face spaced opposite the inner face and wherein the cured film is disposed on the surface adjacent to and in contact with the outer face.

10. The secondary energy storage device of claim 1, wherein the cured film has a thickness of from 10 microns to 400 microns.

11. The secondary energy storage device of claim 1, wherein the feature is a cell terminal.

12. The secondary energy storage device of claim 1, wherein the feature is an entirety of the surface.

13. A vehicle including the secondary energy storage device of claim 1.

14. A secondary energy storage device comprising:
a rigid enclosure having a rectangular prism shape and defining a cavity therein, wherein the rigid enclosure includes a surface having a feature that is protectable from contact with at least one of a gas and a particle present in an environment ambient to the surface and having a temperature that is higher than a melting point temperature of the feature; and
a ceramic coating disposed on and covering the feature and configured to reinforce and protect the feature from contact with the at least one of the gas and the particle.

15. The secondary energy storage device of claim 14, wherein the ceramic coating is a ceramic yarn tape that includes an adhesive disposed in contact with the surface.

16. A method of forming a secondary energy storage device, the method comprising:
placing a polymeric film on a feature of a surface of a rigid enclosure;
wherein the rigid enclosure has a rectangular prism shape and defines a cavity therein; and
wherein the feature is protectable from contact with at least one of a gas and a particle present in an environment ambient to the surface and having a temperature that is higher than a melting point temperature of the feature;
disposing a curable ceramic coating on the polymeric film to thereby cover the polymeric film;
curing the curable ceramic coating to form a cured film disposed on and covering the polymeric film;
wherein the cured film is configured to reinforce and protect the feature from contact with the at least one of the gas and the particle; and
after curing, assembling the rigid enclosure to thereby seal the cavity from the environment ambient to the surface and thereby form the secondary energy storage device.

17. The method of claim 16,
wherein disposing includes spraying the curable ceramic coating in slurry form onto the polymeric film; and
wherein curing includes fully hardening the curable ceramic coating before assembling the rigid enclosure.

18. The method of claim 16, wherein the rigid enclosure includes a front face extending along a central longitudinal axis and the surface is a cap plate that is disposed perpendicular to the front face and extends along an axis that is parallel to the central longitudinal axis; and
further including, after curing, attaching the cap plate to the front face.

19. The method of claim 18, wherein disposing the curable ceramic coating on the polymeric film includes coating a first portion of the surface that is less than an entirety of the surface to thereby form a second portion of the surface that is free from the curable ceramic coating; and
wherein attaching includes welding the cap plate to the front face at the second portion.

20. The method of claim 19, wherein coating the first portion includes applying a mask to the surface at the second portion.
